(19) United States
(12) Patent Application Publication
(10) Pub. No.: US 2005/0104964 A1
(43) Pub. Date: May 19, 2005

(54) Method and apparatus for background segmentation based on motion localization

(76) Inventors: Alexandr V Bovyrin, Nizhny Novgorod (RU); Viktor Lvovich Eruhimov, Nizhny Novgorod (RU); Sergei A Molinov, Nizhny Novgorod (RU)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/451,517

(22) PCT Filed: Oct. 22, 2001
(86) PCT No.: PCT/RU01/00436

(51) Int. Cl. H04N 7/18

(52) U.S. Cl. 348/155; 348/143

(57) ABSTRACT

A system (1000) and method of detecting static background on a video sequence of images with moving foreground objects is described. The method includes localizing moving objects in each frame and training a background model using the rest of the image. The system is also capable of handling occasional background changes and camera movements.

### FIELD OF THE INVENTION

This invention relates to the field of motion detection and, in particular, to background segmentation based on motion localization.

### BACKGROUND OF THE INVENTION

Video conferencing and automatic video surveillance has been growing area driven by the increasing availability of lower priced systems and improvements in motion detection technology. Video display technology provides for the display of sequences of images through a display image rendering device such as a computer display. The sequence of images is time varying such that it can adequately represent motion in a scene.

A frame is a single image in the sequence of images that is sent to the monitor. Each frame is composed of picture elements (pels or pixels) that are the basic unit of programming color in an image or frame. A pixel is the smallest area of a monitor's screen that can be turned on or off to help create the image with the physical size of a pixel depending on the resolution of the computer display. Pixels may be formed into rows and columns of a computer display in order to render a frame. If the frame contains a color image, each pixel may be turned on with a particular color in order to render the image. The specific color that a pixel describes is some blend of components of the color spectrum such as red, green, and blue.

Video sequences may contain both stationary objects and moving objects. Stationary objects are those that remain stationary from one frame to another. As such, the pixels used to render a stationary object's colors remain substantially the same over consecutive frames. Frame regions containing objects with stationary color are referred to as background. Moving objects are those that change position in a frame with respect to a previous position within an earlier frame in the image sequence. If an object changes its position in a subsequent frame with respect to its position in a preceding frame, the pixels used to render the object's image will also change color over the consecutive frames. Such frame regions are referred to as foreground.

Applications such as video display technology often rely on the detection of motion of objects in video sequences. In many systems, such detection of motion relies on the technique of background subtraction. Background subtraction is a simple and powerful method of identifying objects and events of interest in a video sequence. An essential stage of background subtraction is training a background model to learn the particular environment. Most often this implies acquiring a set of images of a background for subsequent comparison with test images where foreground objects might be present. However this approach experiences problems in applications where the background is not available or changes rapidly.

Some prior art methods that deal with these problems are often referred to as background segmentation. The approaches to the task of background segmentation can be roughly classified into two stages: motion segmentation and background training. Motion segmentation is used to find regions in each frame of an image sequence that correspond to moving objects. Motion segmentation starts from a motion field obtained from optical flow calculated on two consecutive frames. The motion field is divided into two clusters using k-means. The largest group is considered a background.

Background training trains background models on the rest of the image. Model-based background extraction extracts background from “museum-like” color images based on assumptions about image properties. This includes small numbers of objects on a background that is relatively smooth with spatial color variations and slight textures.

The problem with these prior background segmentation solutions is that they propose pixel-based approaches to motion segmentation. A pixel-based approach analyses each pixel to make a decision whether it belongs to background or not. Hence, the time T of processing each pixel (T) is the sum of motion detection time (T1) and background training time (T2). If a frame consists of N pixels then the time of processing a single frame is T*N. Such an approach may be robust but it is very time-consuming.

### BRIEF DESCRIPTION OF THE DRAWINGS

The present invention is illustrated by way of example and not intended to be limited by the figures of the accompanying drawings.

FIG. 1 illustrates one embodiment of a method for extracting a background image from a video sequence.

FIG. 2A illustrates an exemplary frame from a video sequence.

FIG. 2B illustrates another exemplary frame from the video sequence subsequent to the frame of FIG. 2A.

FIG. 2C illustrates an exemplary embodiment of a change detection image.

FIG. 2D illustrates an exemplary embodiment of the border contours of the change detection image of FIG. 2C.

FIG. 2E illustrates an exemplary embodiment of hull construction.

FIG. 3 illustrates one embodiment of an iterative construction of a hull.

FIG. 4 illustrates one embodiment of a background training scheme.

FIG. 5 illustrates an exemplary embodiment of the relative dispersion of running averages depending on a.

FIG. 6 illustrates exemplary features to track on an exemplary frame background.

FIG. 7 illustrates one embodiment of camera motion detection and compensation.

FIG. 8 is an exemplary illustration of the percent of moving pixels segmented by a motion localization algorithm.

FIG. 9 is an exemplary illustration of the percent of background pixels segmented as foreground obtained with a motion localization algorithm.

FIG. 10 illustrates one embodiment of a computer system with a camera.

### DETAILED DESCRIPTION

In the following description, numerous specific details are set forth such as examples of specific systems, techniques, components, etc. in order to provide a thorough understanding of the present invention. It will be apparent, however, to one skilled in the art that these specific details need not be employed to practice the present invention. In other instances, well known components or methods have not been described in detail in order to avoid unnecessarily obscuring the present invention.

The present invention includes various steps, which will be described below. The steps of the present invention may be performed by hardware components or may be embodied in machine-executable instructions, which may be used to cause a general-purpose or special-purpose processor programmed with the instructions to perform the steps. Alternatively, the steps may be performed by a combination of hardware and software.

The present invention may be provided as a computer program product, or software, that may include a machine-readable medium having stored thereon instructions, which may be used to program a computer system (or other electronic devices) to perform a process according to the present invention. A machine readable medium includes any mechanism for storing or transmitting information in a form (e.g., software, processing application) readable by a machine (e.g., a computer). The machine-readable medium may includes, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, optical, acoustical or other form of propagated signal (e.g., carrier waves, infrared signals, digital signals, etc.); or other type of medium suitable for storing electronic instructions.

The present invention may also be practiced in distributed computing environments where the machine readable medium is stored on and/or executed by more than one computer system. In addition, the information transferred between computer systems may either be pulled or pushed across the communication medium connecting the computer systems.

Some portions of the description that follow are presented in terms of algorithms and symbolic representations of operations on data bits that may be stored within a memory and operated on by a processor. These algorithmic descriptions and representations are the means used by those skilled in the art to effectively convey their work. An algorithm is generally conceived to be a self-consistent sequence of acts leading to a desired result. The acts are those requiring manipulation of quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, parameters, or the like.

A method and system for extracting a background image from a video sequence with foreground objects is described. Background regions in a frame that are not occluded by foreground objects during a video sequence may be captured by processing individual frames of the video sequence.

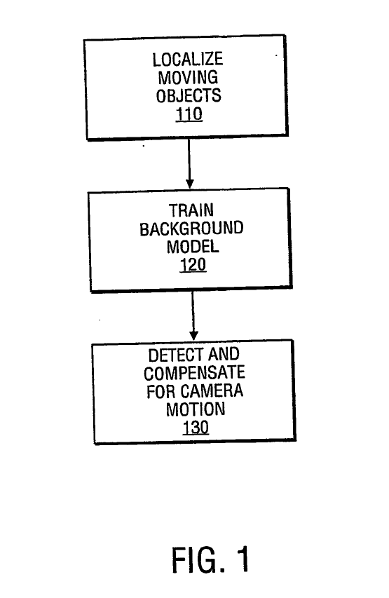

FIG. 1 illustrates one embodiment of a method for extracting a background image from a video sequence. In one embodiment, the method may include localization of moving objects in an image using a change detection mask, step 110, and training a background model of the remaining regions of the image, step 120. In localizing moving objects, step 110, the boundaries of moving objects that are of homogenous color for at least two consecutive frames are marked by constructing one or several hulls that enclose regions corresponding to the moving objects. The rest of the image is regarded as background and is used for training a background model in step 120. In one embodiment, the background may also be used to detect and compensate for camera motion, step 130.

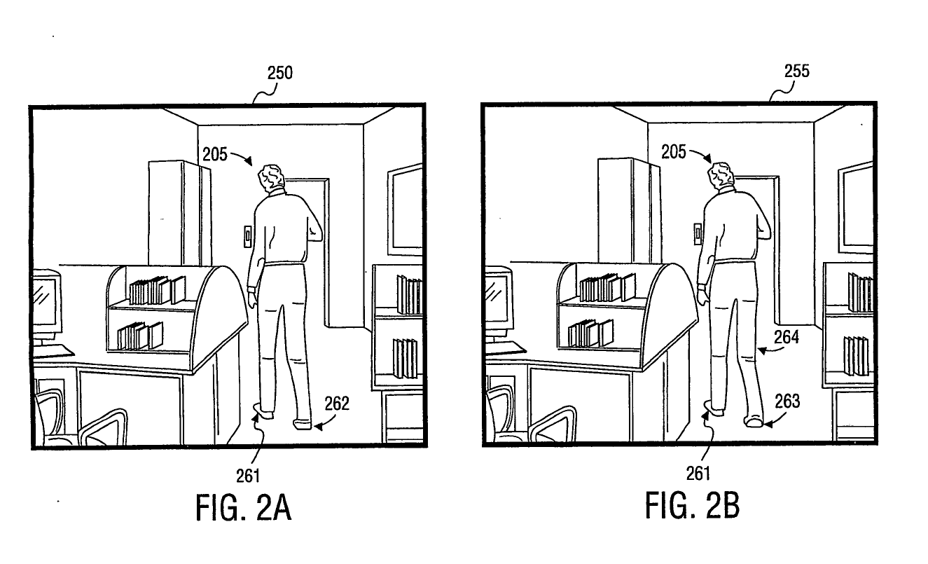

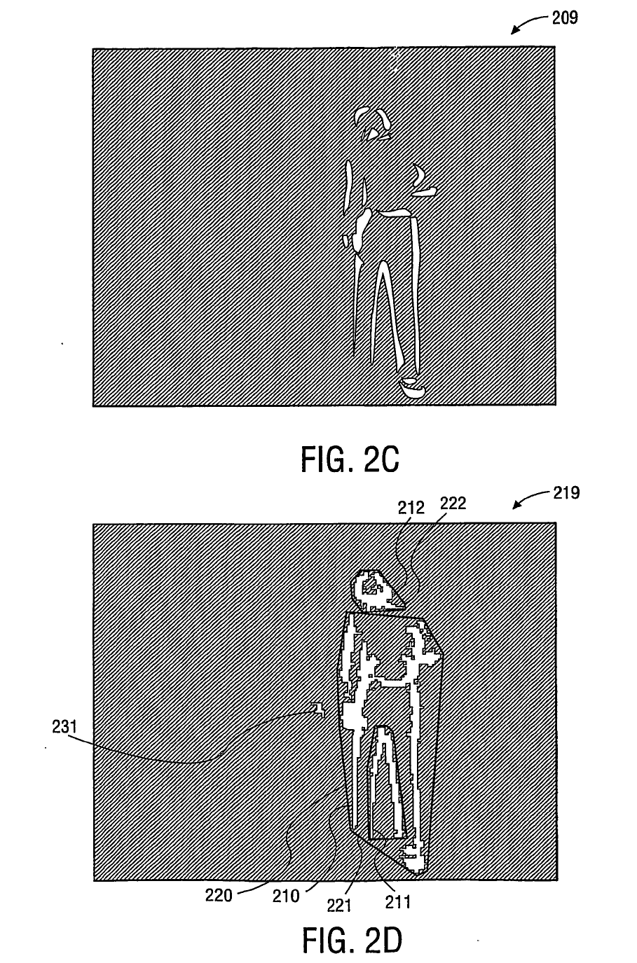

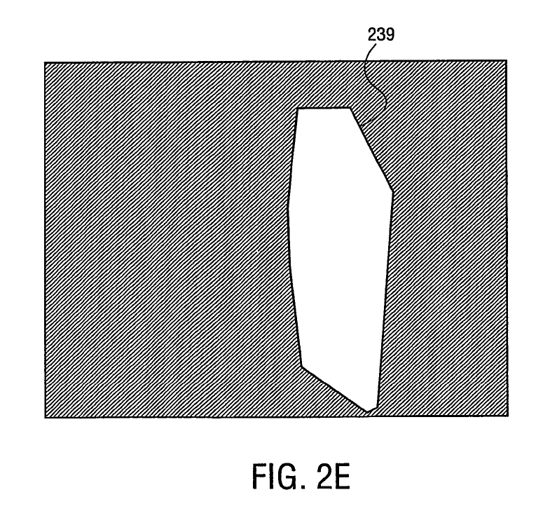

FIGS. 2A and 2B shows two consecutive frames from the same video sequence. As an example of step 110 of FIG. 1, suppose that the images in the video sequence represents only one moving object 205 (e.g., parts of a walking person) that is color homogenous. On frame 255, parts of the walking person 205 may have changed position relative to their position in frame 250. The difference of these two image frames 250 and 255 is the object, or parts thereof, that has moved and is shown as the change detection image 209 illustrated in FIG. 2C. For example, the person's left foot 261 is almost invisible in the image 209 because the person is taking a step with the right leg 264 while keeping the left foot 262 substantially immovable on the floor. As such, the person's left foot 262 does not appear in change detection image 209. In contrast, the heel 263 of the person's right foot 264 has risen from frame 250 to frame 255 and, therefore, appears in change detection image 209.

The application of a change detection mask 219 marks only the border contours 210, 211, and 212 of color homogenous moving regions 209, not the entire regions themselves, as illustrated in FIG. 2D. For example: contour 210 corresponds to the border around the torso, arms, and outer legs of object 205; contour 211 corresponds to the border around the inner legs of moving object 205; and contour 212 corresponds to the head and neck of moving object 205. As a result, the change detection mask 219 contains a much fewer number of pixels than the entire number of pixels in a frame. The use of a change detection algorithm for a high resolution image with subsequent processing of the change detection mask for motion localization takes much less time than the application of a complicated raster technique like optical flow.

All moving objects are localized by applying a fast connected components analysis to the change detection mask 219 that constructs a hull 239 around the contour of each moving region, as illustrated in FIG. 2E. For example, hull 220 is constructed around contour 210, hull 221 is constructed around contour 211, and hull 222 is constructed around contour 212.

Let Iₜ be the image at time t, mₜ ⊂ Iₜ—the set of pixels that correspond to actually moving objects and Mₜ ⊂ Iₜ—the set of pixels that belong to one of the hulls. Localization means that Mₜ should enclose mₜ. In practice, if a pixel p belongs to Sₜ=Iₜ−Mₜ then it corresponds to a static object with a high degree of confidence.

In order to find moving objects, a change detection algorithm is applied to the video sequence frames (e.g., frames 250 and 255). In one embodiment, for example, a change detection algorithm as discussed in “Introductory Techniques for 3-D Computer Vision” by Emaluel Trucco and Alessandro Verri, Prentice Hall, 1998, may be used. Alternatively, other change detection algorithms may be used. Moreover, a change detection algorithm may be selected based on a particular application need.

If for any n

$$\vert {X}_{t}^{( n )} - {X}_{t - 1}^{( n )} \vert < {β}_{CD}^{( n )}$$

then the pixel is considered moving, where β_{CD}⁽ⁿ⁾ is the maximum change in successive running average values such that the background model for the pixel is considered trained. The threshold β_{CD}⁽ⁿ⁾ is chosen as a multiplication of σ⁽ⁿ⁾ calculated from a sequence of images of a static scene, where is a standard deviation of a Normal distribution of a pixel color in case of one or several color channels. In one embodiment, the change detection mask marks noise and illumination change regions in addition to boundaries of color homogenous moving regions. As previously mentioned, to localize the moving object, a hull of these regions is constructed so that it contains moving pixels and does not occupy static pixels as far as possible.

The moving object is the accumulation of the change detection regions at the current time moment t. For the sake of simplicity, an assumption may be made that there is only one moving object. All connected components in the change detection mask and their contours are found. In one embodiment, in order to get rid of noise contours (e.g., contour 231 of FIG. 2D), regions with small areas are filtered out. Then, the contour Cₘₐₓ with the biggest area (which corresponds to the object or its boundary) is selected, for example, contour 220 of FIG. 2D. An iterative construction of the hull H is started by jointing Cₘₐₓ with other contour areas (e.g., contours 221 and 222). These other contour areas represent other moving regions of the moving object 205.

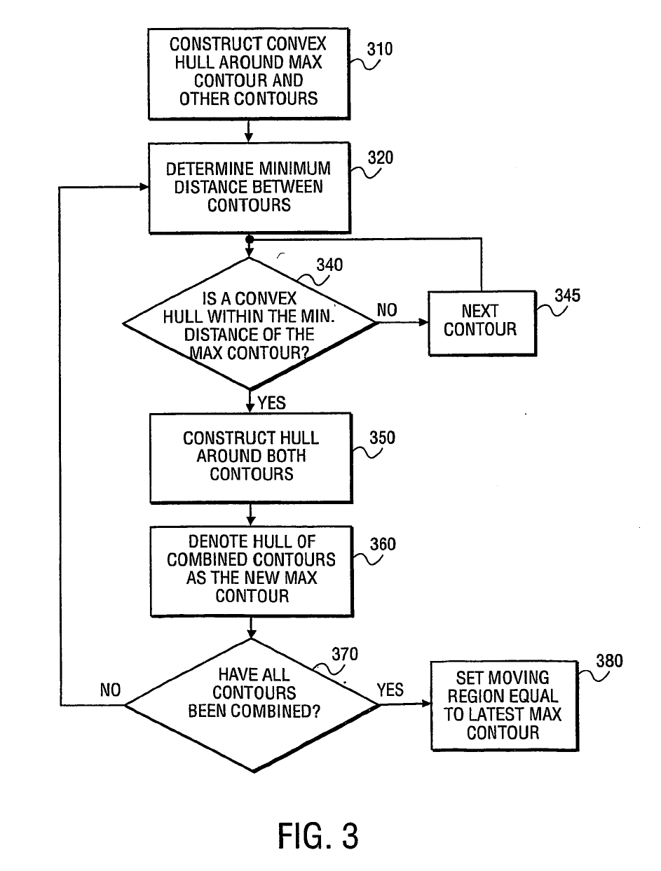

FIG. 3 illustrates one embodiment of an iterative construction of a hull. In step 310, for all contours C_{b} their convex hulls are constructed. A convex hull is the smallest convex polygon that contains one or several moving region components. A convex hull of a contour Cᵢ is denoted by Hᵢ and the convex hull of Cₘₐₓ is denoted by Hₘₐₓ. In step 320 the index k is found such that the euclidean distance between Hₖ and Hₘₐₓ is the minimum one:
k=arg min(dist(Hᵢ, Hₘₐₓ)) and dₖ=min dist (Hᵢ, Hₘₐₓ).

In step 340, determine if a convex hull is within the minimum distance Dₘₐₓ of the convex hull of Cₘₐₓ (dₖ is less than a threshold Dₘₐₓ). If so, then a convex hull Ĥmax is constructed around the set of hulls Hₖ and Hₘₐₓ, step 350. If not, then repeat step 340 for the next contour, step 345. In step 360, denote Hₘₐₓ=Ĥmax and, in step 370 determine all contours have been considered. Then, repeat from step 320 unless all Cᵢ have already been considered. Otherwise go to step 380. In step 380, set the moving region equal to the latest maximum contour (Mₜ=Hₘₐₓ). The above steps may be generalized for the case of several moving objects.

The quality of the above algorithm can be estimated using two values. The first is the conditional probability that the pixel is considered moving given that it really corresponds to a moving object:
P₁=P(pεMₜ|pεmₜ).

The second is the conditional probability that the pixel is considered moving given that it is static: P_{2 =P(pεM}ₜ|pεIₜ−mₜ). where Iₜ is the image at time t, mₜ is the set of pixels of Iₜ that corresponds to moving objects, and Mₜ is the set of pixels of Iₜ that have experience considerable change in color over the last one or few frames.

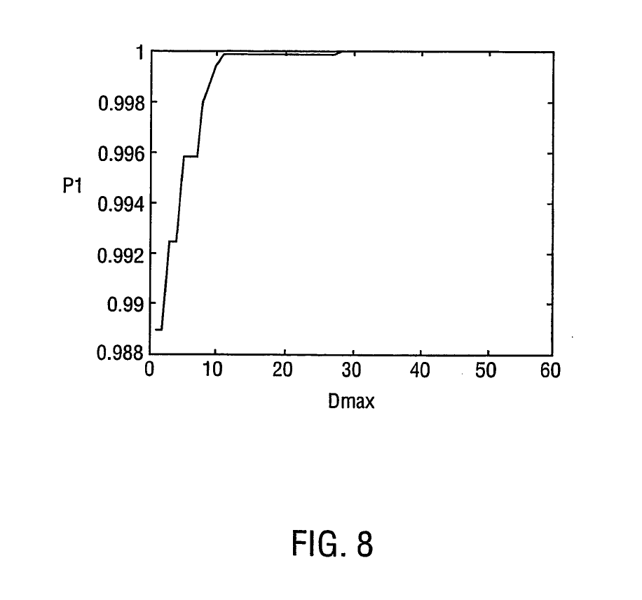

P₁ needs to be as big as possible while P₂ should be small. If P₁ is not big enough then a corrupt background may be trained while having P₂ not sufficiently small will increase the training time. P₁ and P₂ should evidently grow with increase of Dₘₐₓ This defines Dₘₐₓ to be minimum value providing P₁ higher than a certain level of confidence. The selection of Dₘₐₓ is discussed below in relation to FIG. 8.

As previously discussed, the change detection mask marks only boundaries of homogenous moving regions. Moreover, it may not mark regions that move sufficiently slow. Hence, some slowly moving objects may constantly go to background and some moving objects may occasionally be considered to belong to background. One solution to the first problem is to perform change detection several times with different reference frames, for example, one frame before the current frame, two frames before the current frame, etc. One solution to the second problem is to perform background training taking into account that some background frames might be corrupted. At this point two characteristics of the motion localization algorithm are of interest: the probability P^{(m)} that a moving pixel is misclassified m times in a row and the index m* such that P^{(m*)} is below a level of confidence, m* may be used as a parameter for the background training algorithm.

Referring again to FIG. 1, when all the moving regions in a current frame are localized, step 110, a background model with given static pixels of the current frame is trained, step 120. A pixel color may be characterized at a give time moment with three values {X⁽ⁿ⁾}n=1 . . . 3, which in case of a static pixel may be reasonably modeled by Normal distributions N (μ⁽ⁿ⁾, σ⁽ⁿ⁾) with unknown means μ⁽ⁿ⁾ and standard deviations σ⁽ⁿ⁾.

The training is multistage in order to remove out-liers produced by mis-prediction during step 110. Occasional background changes may be handled in a similar manner. If a foreground pixel represents a Normal distribution with small deviation for a long time, it is considered to be a change in the background and the background model is immediately updated. The background subtraction, for example, as discussed in “Non-Parametric Model for Background Subtraction,” Ahmed Elgammal, David Harwood, Larry Davis, Proc. ECCV, Vol. 2, pp. 751-767, 2000, may be used to segment background on every image. In an alternative embodiment, other background subtraction techniques may be used.

During training process, a calculation of the values of μ⁽ⁿ⁾ is performed using a running average update:
μₜ_{ᵢ}⁽ⁿ⁾=(1−α)μₜ_{ᵢ₋₁}⁽ⁿ⁾+αXₜ_{ᵢ}⁽ⁿ⁾, (1)
where tᵢ mark the frames where the pixel was classified as static.

When the sequence converges, that is the difference between μₜ_{ᵢ} and μₜ_{ᵢ₋₁} is swall:

$$\vert {μ}_{{t}_{i}}^{( n )} - {μ}_{{t}_{i - 1}}^{( n )} \vert < {β}^{( n )} , \qquad ( 2 )$$

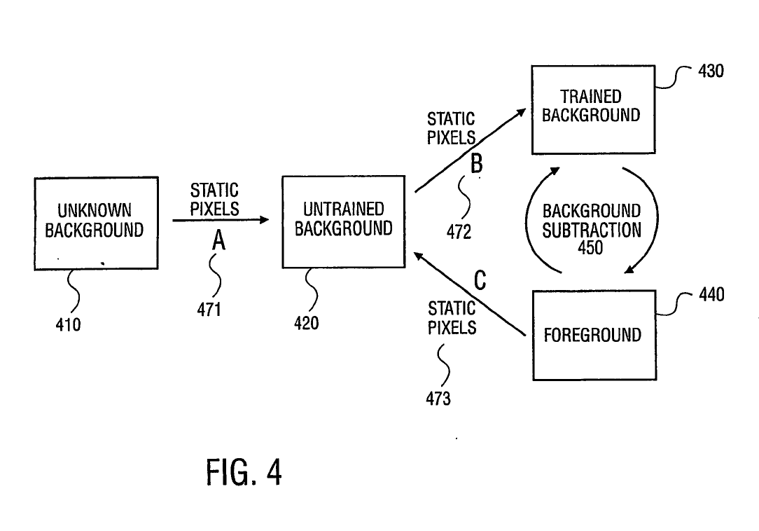

the background model is considered trained in this pixel and μ⁽ⁿ⁾=μₜ_{ᵢ}⁽ⁿ⁾. Therefore each pixel can correspond to one of four states, as illustrated in FIG. 4: unknown background state 410 (that corresponds to pixels that have never been in Sₜ), untrained background state 420 (when statistics are being collected and inequality (2) is not satisfied), trained background state 430 (inequality (2) is satisfied), and foreground state 440 (when the background is trained and foreground is detected on the current image with background subtraction). The possible transitions are shown in FIG. 4. Transition A 471 takes place when pixel appears in Sₜ for the first time. Transition B 472 occurs when the pixel's model is considered to be sufficiently trained. Transition C 473 occurs when the foreground is static for a long time period.

For the sake of simplicity, a pixel at the given time moment t may be characterized with only one value Xₜ. Equation (1) and inequality (2) contain unknown parameters a and β which define the training process. The appropriate choice of these parameters gives a fast and at the same time statistically optimal background training. Assuming that X₁=I+Δₜ where I is a constant color value of a background pixel and Δ is a zero-mean Gaussian noise in the color of a pixel at time t with standard deviation σΔ, then for δₜ=μₜ−I we will have the following equation δₜ=(1−α)δₜ_{ᵢ₋₁}+αΔₜ_{ᵢ}, where δₜ is the difference of the running average and constant background color.

δₜ will be normally distributed with mean <δₜ> and deviation σₜ <δₜ_{ᵢ}>=(1−α)ⁱδₜ_{ₒ}, where a is the running average constant

$${α}_{{t}_{l}}^{2} = {δ}_{Δ}^{2} ( \frac{α}{2 - α} ( 1 - {( 1 - α )}^{2 i} ) + {( 1 - α )}^{2 i} ) \qquad ( 3 )$$

In order to have a robust background, the background should be trained long enough to make sure that it is not trained by a moving object. In other words, if the pixel value changes significantly, the training should endure for at least m* frames. Hence, the following inequality should be fulfilled:
β≦α(1−α)^{m*-1}δₜ_{ₒ}, (4)
where δₜ_{ₒ} is equal to σ Δ and m* is the minimum number of successive frames such that the probability P^{(m*)} is below the level of confidence; in other words, an assumption may be made that no pixel is misclassified through all m* successive frames. In one embodiment, there may be no reason to make β smaller than the value defined in inequality 4 since it will dramatically increase the background training time.

At the same time, the standard deviation of δ_{m*} should be as small as possible. It can be proved that ζ=σₜ_{ᵢ}²/σ_{Δ}² as a function of αε[0,1] has one minimum a=a*ᵢ where

$${α}_{i}^{*} = {arg min}_{α ∈ [ 0 , 1 ]} \{ ( \frac{α}{2 - α} ( 1 - {( 1 - α )}^{2 i} ) + {( 1 - α )}^{2 i} ) ) \} \qquad ( 5 )$$

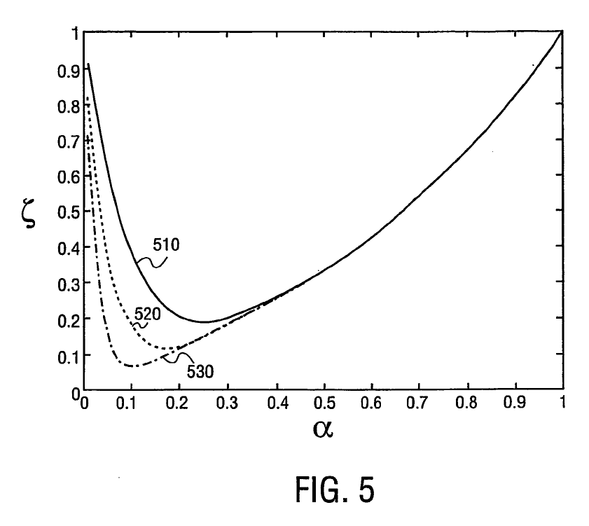

Examples of ζ (α) for different frame numbers are shown in FIG. 5.

FIG. 5 illustrates an exemplary embodiment of the relative dispersion of the running average depending on α. In one embodiment, solid line 510 corresponds to a 5^{th} frame, dashed line 520 corresponds to a 10^{th} frame, and dash-dotted line 530 corresponds to a 20^{th} frame.

Choosing either too low or too high value of a would result in a big statistical uncertainty of δ and of running average μ. α=α_{m*}*. may be chosen so that with a static background pixel, the running average μₜ_{_{m*}} accepted as a background pixel value would have a minimum possible standard deviation. Given m*, inequality 4 and equation 5 define the optimal values of β and α.

In one embodiment, background changes may be considered in training the background model. Suppose that the camera is not moving but the background has changed significantly, though remaining static afterwards. For example, one of static objects has been moved to a different position. The system marks the previous and current places of the object as foreground. Such pixels are not usual foreground pixels but, rather, they are static foreground. This property enables the tracking of such background changes and the adaptation of the background model. The model is trained for each pixel in the foreground and, if it represents a static behavior for a long period of time, its state is changed to an untrained background. After a predetermined number of frames (e.g., three frames) it will become a trained background.

Referring again to FIG. 1, in one embodiment, the background may also be used to detect and compensate for camera motion, step 130. The methods described herein may be generalized to the case of a moving camera by incorporation of fast global motion detection. When part of the image becomes a trained background state 430 of FIG. 4, background subtraction 450 may be applied to every frame and a global motion estimation algorithm run on the found background mask.

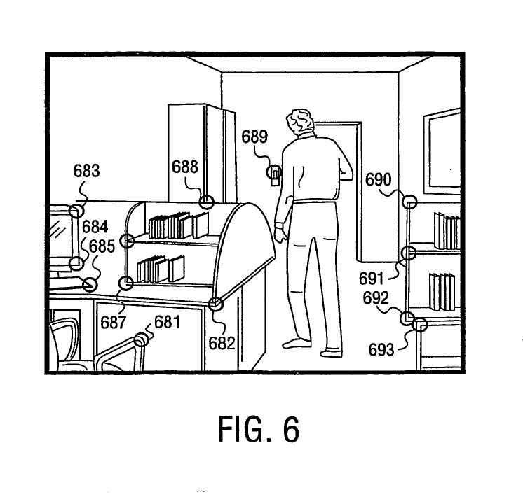

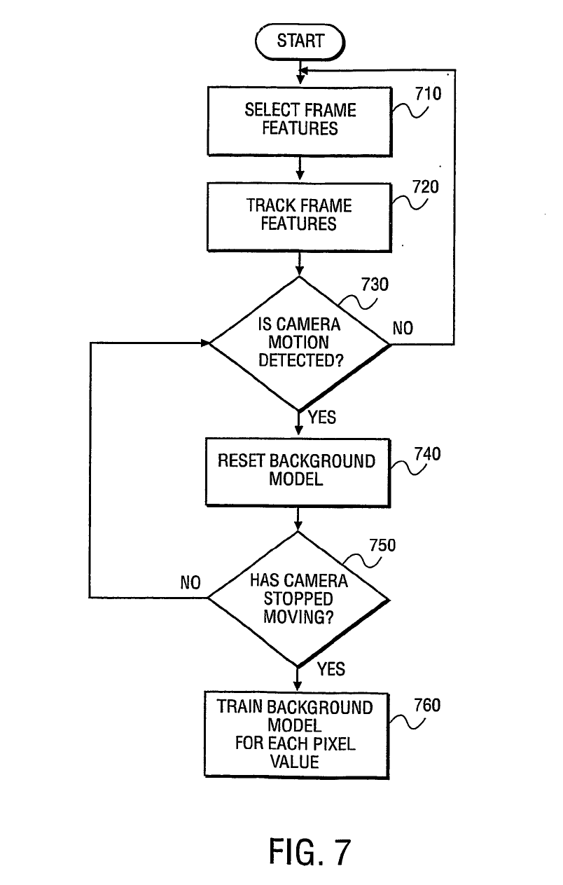

FIG. 7 illustrates one embodiment of camera motion detection and compensation. In one embodiment, frame features are selected to track on a background, step 710, for example, corners 681-693 as illustrated in FIG. 6. Optical flow may be used to track a few strong features in background to determine the camera motion, step 720. In one embodiment, feature selection techniques such as those discussed in “Good Features To Track,” Jianbo Shi, Carlo Tomasi, Proc. CVPR, pp. 593-600, 1994, may be used to select features. In one embodiment, feature tracking techniques such as those discussed in “Introductory Techniques for 3-D Computer Vision” by Emaluel Trucco and Alessandro Verri, Prentice Hall, 1998, may be used to track features. Alternatively, other features and feature selection and tracking methods may be used.

Once global motion is detected in the background indicating camera motion, step 730 then the background model is reset, step 740, by setting all pixels to unknown background state (e.g., state 410 of FIG. 4). Feature tracking provides a good global motion estimation with points being tracked in a stable manner for a long time. If the background pixels are all lost, then the percent of moving pixels from change detection algorithm may be tracked. If a false end of motion is detected (a low change detection rate might take place during camera movement, for example, because of a homogenous background), the motion localization and training steps 110 and 120 of FIG. 1 will filter out incorrect pixel values. When the camera stops moving, step 760, then the background model starts training again for each pixel value (step 120 of FIG. 1).

Some experimental results using the motion localization and background training methods are presented below. It should be noted that the experimental results are provided only to help describe the present invention and are not meant to limit the present invention. In one embodiment, the scheme discussed herein was implemented using Intel® Image Processing Library (IPL) and Intel® Open Source Computer Vision Library (OpenCV), with the system capable of processing 320×240 images for 15 milliseconds (ms). The testing was performed on a large number of video sequences taken with a raw USB video camera.

The motion localization threshold, Dₘₐₓ, may be selected, in one embodiment, according to FIG. 8. FIG. 8 illustrates exemplary results of testing the algorithm on a video sequence and comparing these results with foreground segmentation based on background subtraction. The value of P₁ represents the percent of pixels from the foreground that were classified as moving pixels. In alternative embodiments, Dₘₐₓ may be selected based on other empirical data or by other means, for examples, simulations, models, and assumptions.

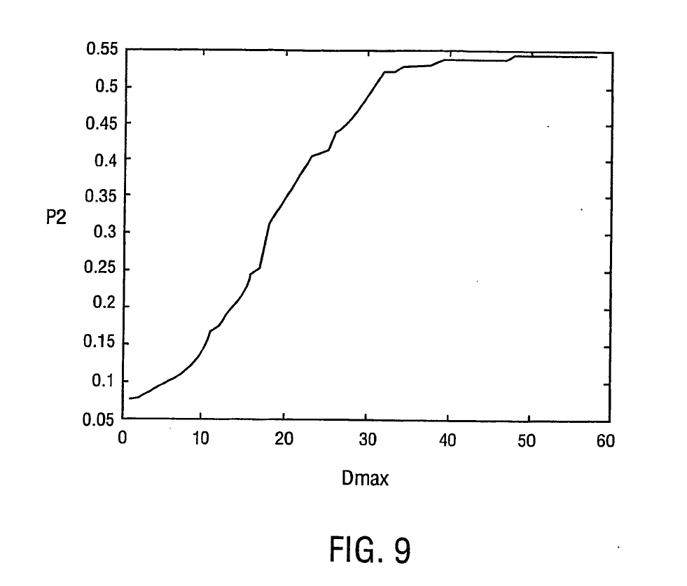

FIG. 9 illustrates the percent of background pixels segmented as foreground obtained with the same methods. P₁ and P₂ discussed above may be varied by using the parameter Dₘₐₓ. For Dₘₐₓ=15, the number n(m) of foreground pixels that are mis-classified m times in a row are calculated. The results are presented in the following table:

| | | | | | | |
|---|---|---|---|---|---|---|
| m | 1 | 2 | 3 | 4 | 5 | 6 |
| n | 542 | 320 | 238 | 128 | 3 | 0 |

Taking m*=5 gives α˜0.25 and β˜0.71 for inequality (4) and equation (5) presented above.

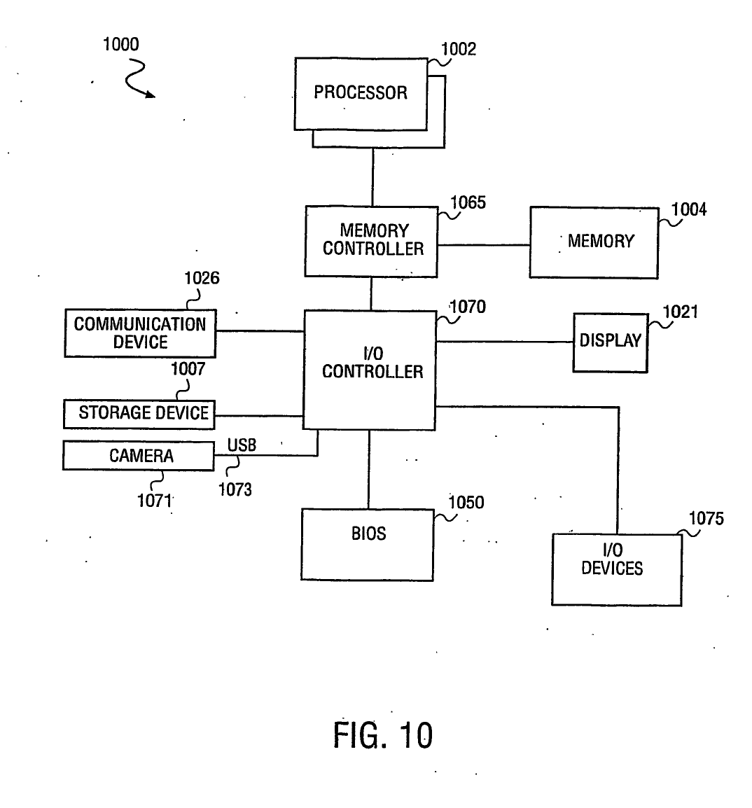

FIG. 10 illustrates one embodiment of a computer system (e.g., a client or a server) in the form of a digital processing system representing an exemplary server, workstation, personal computer, laptop computer, handheld computer, personal digital assistant (PDA), wireless phone, television set-top box, etc., in which features of the present invention may be implemented. Digital processing system 1000 may be used in applications such as video surveillance, video conferencing, robot vision, etc.

Digital processing system 1000 includes one or more buses or other means for transferring data among components of digital processing system 1000. Digital processing system 1000 also includes processing means such as processor 1002 coupled with a system bus for processing information. Processor 1002 may represent one or more general purpose processors (e.g., a Motorola PowerPC processor and an Intel Pentium processor) or special purpose processor such as a digital signal processor (DSP)(e.g., a Texas Instrument DSP). Processor 1002 may be configured to execute the instructions for performing the operations and steps discussed herein. For example, processor 1002 may be configured to process algorithms to localize a moving object in frames of a video sequence.

Digital processing system 1000 further includes system memory 1004 that may include a random access memory (RAM), or other dynamic storage device, coupled to memory controller 1065 for storing information and instructions to be executed by processor 1002. Memory controller 1065 controls operations between processor 1002 and memory devices such as memory 1004. Memory 1004 also may be used for storing temporary variables or other intermediate information during execution of instructions by processor 1002. Memory 1004 represents one or more memory devices, for example, memory 1004 may also include a read only memory (ROM) and/or other static storage device for storing static information and instructions for processor 1002.

Digital processing system 1000 may also include an I/O controller 1070 to control operations between processor 1002 and one or more input/output (I/O) devices 1075, for examples, a keyboard and a mouse. I/O controller 1070 may also control operations between processor 1002 and peripheral devices, for example, a storage device 1007. Storage device 1007 represents one or more storage devices (e.g., a magnetic disk drive or optical disc drive) coupled to I/O controller 1070 for storing information and instructions. Storage device 1007 may be used to store instructions for performing the steps discussed herein. I/O controller 1070 may also be coupled to BIOS 1050 to boot digital processing system 1000.

Digital processing system also includes a video camera 1071 for recording and/or playing video sequences. Camera 1071 may be coupled to I/O controller 1070 using, for example, a universal serial bus (USB) 1073. Alternatively, other types of buses may be used to connect camera 1071 to I/O controller 1070, for example, a fire wire bus. Display device 1021, such as a cathode ray tube (CRT) or Liquid Crystal Display (LCD), may also be coupled to I/O controller 1070 for displaying video sequences to a user.

A communications device 1026 (e.g., a modem or a network interface card) may also be coupled to I/O controller 1070. For example, the communications device 1026 may be an Ethernet card, token ring card, or other types of interfaces for providing a communication link to a network for which digital processing system 1000 is establishing a connection. For example, communication device 1026 may be used to receive data relating to video sequences from another camera and/or computer system over a network.

It should be noted that the architecture illustrated in FIG. 10 is only exemplary. In alternative embodiments, other architectures may be used for digital processing system 1000. For examples, memory controller 1065 and the I/O controller 1070 may be integrated into a single component and/or the various components may be coupled together in other configurations (e.g., directly to one another) and with other types of buses.

A novel and fast method of background extraction from a sequence of images with moving foreground objects has been presented. The method employs image and contour processing operations and is capable of robust extraction of background for a small number of frames. For example, the methods may operate for about 30 frames on a typical videoconferencing image sequence with a static background and a person in the foreground. This is a significant advantage in the context real-time video applications such as surveillance and robotic vision over prior art systems that rely on computationally expensive operations. The methods of the present invention may be applied to a wide range of problems that deal with stationary background and objects of interest in foreground. In addition, the versatility of the system allows for the selection of a change detection algorithm to a particular application need. Such methods may also be used in conjunction with video compression taking advantage of the knowledge of static regions in a sequence.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method of extracting a background image, comprising:
localizing a moving object in a video sequence based on a change in the moving object over a plurality of frames of the video sequence, the moving object occupying frame areas of changing color; and
training a background model for the plurality of frames outside of the frame areas of changing color.

2. The method of claim 1, wherein localizing comprises localizing the moving object using a change detection mask.

3. The method of claim 1, wherein localizing comprises:
determining a boundary for the moving object that is of homogenous color; and
constructing a hull around the moving object using the boundary.

4. The method of claim 3, wherein determining a boundary comprises:
determining a maximum contour of a plurality of contours of the moving object, the maximum contour having the largest area of the plurality of contours;
determining other contours of the moving object; and
joining the maximum contour with the other contours.

5. The method of claim 4, further comprising:
eliminating the smallest contour from joining with the maximum contour.

6. The method of claim 4, wherein joining comprises joining one of the other contours with the maximum contour if the distance between the maximum contour and the one of the other contours is less than a predetermined distance.

7. The method of claim 6, wherein the frames comprise a plurality of pixels and wherein the predetermined distance is based on a probability that a pixel of the plurality of pixels is considered moving given that it corresponds to the moving object.

8. The method of claim 7, wherein the predetermined distance is based on a probability that the pixel is considered moving given that it is static.

9. The method of claim 3, wherein the frames comprise a plurality of pixels and wherein the hull is constructed to contain only pixels of changing colors over consecutive frames.

10. The method of claim 3, wherein constructing the hull comprises:
determining all connected components in the boundary, wherein each of the components has a contour having an area;
filtering out a smallest area contour;
selecting a maximum area contour; and
joining the maximum area contour with other contours of the connected components.

11. The method of claim 1, wherein the frames comprise a plurality of pixels and wherein training comprises characterizing a pixel color at a given time with a value based on a state, each pixel corresponding to a state of a plurality of states.

12. The method of claim 11, wherein the plurality of states includes an untrained background state.

13. The method of claim 11, wherein the plurality of states includes a trained background state.

14. The method of claim 11, wherein the plurality of states includes a foreground state.

15. The method of claim 11, wherein the plurality of states includes an unknown background state.

16. The method of claim 11, wherein training comprises:
training the background model for the pixel in a foreground; and changing the state of the pixel to an untrained background if the pixel represents a static behavior for a certain period of time.

17. The method of claim 16, further comprising changing the state to a trained background after a predetermined number of two frames.

18. The method of claim 1, wherein the video sequence is recorded with a video camera and wherein the method further comprises:
detecting a motion of the video camera; and
compensating for the motion of the video camera.

19. The method of claim 18, detecting the motion comprises:
selecting a frame feature; and
tracking the frame features over the plurality of frames.

20. The method of claim 19, wherein compensating comprises resetting the background model when the motion has stopped.

21. A machine readable medium having stored thereon instructions/which when executed by a processor, cause the processor to perform the following:
localizing a moving object in a video sequence based on a change in the moving object over a plurality of frames of the video sequence/the moving object occupying frame areas of changing color; and
training a background model for the plurality of frames outside of the frame areas of changing color.

22. The machine readable medium of claim 21, wherein localizing comprises localizing the moving object using a change detection mask.

23. The machine readable medium of claim 21, wherein localizing comprises:
determining a boundary for the moving object that is of homogenous color; and
constructing a hull around the moving object using the boundary.

24. The machine readable medium of claim 23, wherein determining a boundary comprises:
determining a maximum contour of a plurality of contours of the moving object, the maximum contour having the largest area of the plurality of contours;
determining other contours of the moving object; and
joining the maximum contour with the other contours.

25. The machine readable medium of claim 24, wherein the processor further performs:
determining a smallest contour of the plurality of contours; and
eliminating the smallest contour from joining with the maximum contour.

26. The machine readable medium of claim 24, wherein joining comprises joining one of the other contours with the maximum contour if the distance between the maximum contour and the one of the other contours is less than a predetermined distance.

27. The machine readable medium of claim 23, wherein the processor performing constructing the hull comprises the processor performing:
determining all connected components in the boundary, wherein each of the components has a contour having an area;
filtering out a smallest area contour;
selecting a maximum area contour; and
joining the maximum area contour with other contours of the connected components.

28. The machine readable medium of claim 21, wherein the frames comprise a plurality of pixels and wherein the processor performing training, comprises the processor performing characterizing a pixel color at a given time with a value based on a state, each pixel corresponding to a state of a plurality of states.

29. The machine readable medium of claim 28, wherein the processor performing training comprises the processor performing:
training the background model for the pixel in a foreground; and
changing the state of the pixel to an untrained background if the pixel represents a static behavior for a certain period of time.

30. The machine readable medium of claim 21, wherein the video sequence is recorded with a video camera and wherein the processor further performs:
detecting a motion of the video camera; and
compensating for the motion of the video camera.

31. The machine readable medium of claim 30, wherein the processor performing detecting the motion comprises the processor performing the following:
selecting a frame feature; and
tracking the frame features over the plurality of frames.

32. The machine readable medium of claim 30, wherein the processor performing compensating comprises the processor performing the following:
resetting the background model when the motion has stopped.

33. An apparatus for extracting a background image, comprising:
means for localizing a moving object in a video sequence based on a change in the moving object over a plurality of frames of the video sequence, the moving object occupying frame areas of changing color; and
means for training a background model for the plurality of frames outside of the frame areas of changing color.

34. The apparatus of claim 33, wherein the means for localizing comprises:
means for determining a boundary for the moving object that is of homogenous color; and
means for constructing a hull around the moving object using the boundary.

35. The apparatus of claim 33, wherein the video sequence is recorded with a video camera and wherein the apparatus further comprises:
means for detecting a motion of the video camera; and
means for compensating for the motion of the video camera.

36. An apparatus for extracting a background image, comprising:
a processor to execute one or more routines to localize a moving object in a video sequence based on a change in the moving object over a plurality of frames of the video sequence, the moving object occupying frame areas of changing color, and to train a background model for the plurality of frames outside of the frame areas of changing color; and
a storage device coupled with the processor, the storage device having stored therein the one or more routines to localize the moving object and train the background model.

37. The apparatus of claim 36, wherein the processor executes one or more routines to localize the moving object using a change detection mask.

38. The apparatus of claim 36, wherein the processor executes one or more routines to determine a boundary for the moving object that is of homogenous color and to construct a hull around the moving object using the boundary.

39. The apparatus of claim 36, further comprising a display coupled with the processor to display the plurality of frames of the video sequence.

40. The apparatus of claim 36, further comprising a camera coupled with the processor to record the plurality of frames of the video sequence.

41. The apparatus of claim 40, wherein the processor executes one or more routines to detect a motion of the video camera to compensate for the motion of the video camera.
